(19) United States
(12) Patent Application Publication
(10) Pub. No.: US 2002/0038737 A1
(43) Pub. Date: Apr. 4, 2002

(54) FOOT BOARD ARRANGEMENT FOR ALL-TERRAIN VEHICLE

(75) Inventors: YOSHIHIRO MORISHITA, IWATA-SHI (JP); TAKASHI SUZUKI, IWATA-SHI (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(73) Assignee: Yoshihiro Morishita et al

(21) Appl. No.: 09/268,946

(22) Filed: Mar. 16, 1999

(51) Int. Cl. B60N 2/00; B60K 1/00

(52) U.S. Cl. 180/291; 180/90.6; 280/291; 280/760; 296/198

(57) ABSTRACT

An all-terrain vehicle has a removable foot board arrangement. The foot boards are removably mounted to a mounting fixtures. The mounting fixtures are removably mounted to a set of corresponding mounting brackets. The mounting brackets are secured to the frame of the all-terrain vehicle. The foot boards extend outward beyond an outermost portion of the rims of the front wheels and serve as side guards.

### BACKGROUND OF THE INVENTION

1. Field of the Invention

The present invention generally relates to a body and frame arrangement for an all-terrain vehicle and, more particularly, to an foot board arrangement for the all-terrain vehicle.

2. Description of Related Art

Due to their desired environments of use, all-terrain vehicles are often encounter rocks, sticks, logs, and the like. While operating in this hazardous environment, rocks can be thrown into the body of the all-terrain vehicle, resulting in damage to the body components. One such component which is frequently damaged is the foot board.

In the past, the foot board has been welded to the frame of the all-terrain vehicle during manufacturing. The welding of the foot boards to the frame required the entire frame to be electroplated and, therefore, increased the size of the tub required (i.e., the foot boards extend out to the sides of the balance of the frame). Additionally, they hampered transportation of the all-terrain vehicles due to their protrusion to the sides of the frame. Furthermore, when damaged, they were difficult to remove and replace without expensive welding repairs.

The body components also were damaged while turning, if the all-terrain vehicle brushed against rock formations, for example. Thus, the turning angle of the all-terrain vehicle could result in an obstruction banging into a rear fender and damaging the fender or hanging the all-terrain vehicle up against the obstruction. Additionally, the legs of the operator could be easily struck by the obstruction when passing by it.

### SUMMARY OF THE INVENTION

Accordingly, one aspect of the present invention involves an all-terrain vehicle having a frame assembly. A pair of front wheels and a pair of rear wheels are mounted to the frame assembly. A seat is arranged behind the pair of front wheels. The all-terrain vehicle also has a plurality of mounting brackets attached to the frame assembly between the front wheels and the rear wheels. The mounting brackets are arranged below a portion of the seat. A foot board is removably attached to the brackets.

Another aspect of the present invention involves an all-terrain vehicle having a central longitudinal plane and a pair of foot boards. The foot boards are arranged between a pair of front wheels and a pair of rear wheels. The front wheels have a corresponding pair of rims and a maximum turning position. The foot boards desirably have an outer edge which extends further outward from the central longitudinal plane than an outermost portion of the rims when the rims are in the maximum turning position.

### BRIEF DESCRIPTION OF THE DRAWINGS

These and other features, aspects and advantages of the present invention will now be described with reference to the following drawings of a preferred embodiment that is intended to illustrate and not to limit the present invention, and in which:

FIG. 1 is a right side view of a motor vehicle constructed in accordance with an embodiment of the present invention, with some internal components illustrated with hidden lines;

FIG. 2 is a top view of the motor vehicle of FIG. 1, with some internal components illustrated with hidden lines;

FIG. 3 is a front view of the motor vehicle of FIG. 1;

FIG. 4 is a left side view of a frame of the motor vehicle of FIG. 1, with some additional components illustrated with phantom lines and with other internal components illustrated with hidden lines;

FIG. 5 is a bottom view of a portion of the frame of FIG. 4, with some internal components illustrated with hidden lines;

FIG. 6 is a top view of a portion of the frame of FIG. 4, with some internal components illustrated with hidden lines;

FIG. 7 is a left side view of a front portion of the frame illustrated in FIG. 4, with some components illustrated with phantom lines and with some internal components illustrated with hidden lines;

FIG. 8 is a sectional view of a portion of FIG. 7 taken through the line 8-8;

FIG. 9 is a left side view of a rear portion of the frame illustrated in FIG. 4, with some components illustrated with phantom lines and with some internal components illustrated with hidden lines;

FIG. 10 is a sectional view of FIG. 9 taken through the line 10-10 which illustrates the attachment of a storage box and a silencer to frame components;

FIG. 11 is a sectional view of a portion of FIG. 4 taken through line 11-11;

FIG. 12 is a sectional view of a portion of FIG. 4 taken through line 12-12, with a portion of the crankcase illustrated with phantom lines;

FIG. 13 is a right side view of an engine configured in accordance with aspects of the present invention with some internal components illustrated with hidden lines;

FIG. 14 is a top view of the engine of FIG. 13, with some internal components illustrated with hidden lines;

FIG. 15 is a front view of a portion of an air intake system and an induction system configured in accordance with aspects of the present invention, with some internal components illustrated with hidden lines;

FIG. 16 is a left side view of a portion of the motor vehicle of FIG. 1, illustrating the fuel tank and frame with the seat illustrated with phantom lines and some internal components illustrated with hidden lines;

FIG. 17 is a front view of the portion of the motor vehicle illustrated in FIG. 16, with some internal components illustrated with hidden lines;

FIG. 18 is a top view of the portion of the motor vehicle illustrated in FIG. 16, with some internal components illustrated with hidden lines;

FIG. 19 is a partial top view of FIG. 1, which illustrates a right side foot board and brake components, with some internal components illustrated with hidden lines;

FIG. 20 is a sectional view of a portion of FIG. 19 taken along the line 20-20;

FIG. 21 is a partial right side view of FIG. 19, with some internal components illustrated with hidden lines and some surrounding structures illustrated with phantom lines;

FIG. 22 is a sectional view of a portion of FIG. 19 taken along the line 22-22; and

FIG. 23 is a sectional view of a portion of FIG. 19 taken along the line 23-23.

### DETAILED DESCRIPTION OF THE PREFERRED EMBODIMENTS OF THE INVENTION

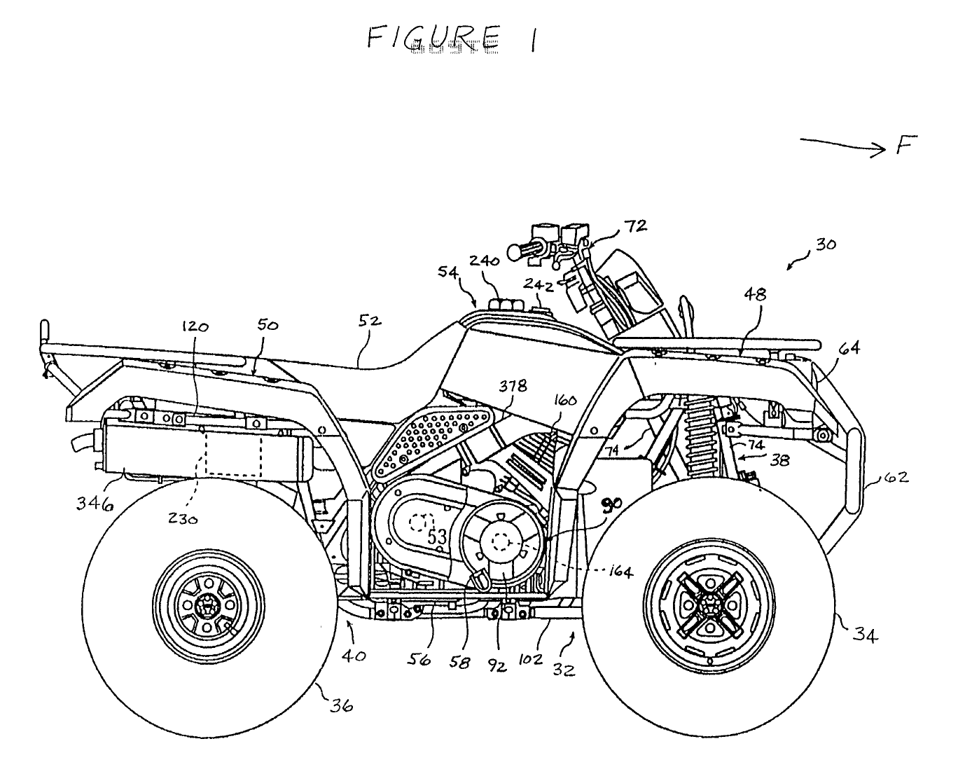

With reference to FIGS. 1-3, a motor vehicle of the four-wheel type constructed in accordance with an embodiment of the present invention is identified generally by reference numeral 30. The motor vehicle 30 is preferably propelled in a forward direction, indicated by the arrow F, but may also be propelled rearward as is well known. The vehicle 30, as will be described, illustrates only a typical environment in which the present invention may be found. For that reason, many details of the motor vehicle 30, which are not necessary to understand the construction and operation of the present invention, will be omitted; however, the omitted details are considered well understood by those of skill in the art.

The motor vehicle 30 generally includes a welded-up tubular frame assembly 32 and a pair of front wheels 34 and a pair of rear wheels 36. Preferably, each of the wheels 34, 36 is a low-pressure balloon-type of tire designed for off-road use.

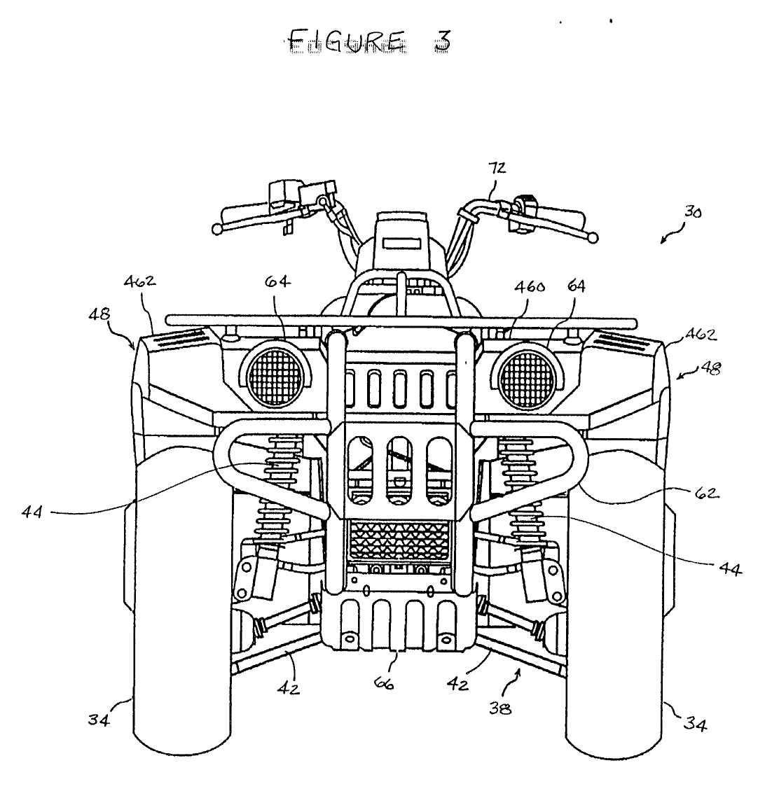

The travel of each pair of wheels 34, 36 is controlled through corresponding front and rear suspension systems 38, 40. The front suspension system 38 generally comprises two independent mechanisms, one for each of the front wheels 34. With reference to FIG. 3, each illustrated mechanism has an A-arm 42 that carries a respective carrier hub (not shown) at its outermost end (i.e., the apex of the A). The innermost end (i.e., the base of the A) is pivotably connected to the welded-up tubular frame assembly 32. As is known, a shock absorber assembly 44 may be attached to each front wheel 34, at the carrier hub (not shown) in the illustrated embodiment, and extends upward to a connecting point flange (not shown) on the frame assembly 32. The travel of each of the front wheels 34 is thereby controlled independently of the other.

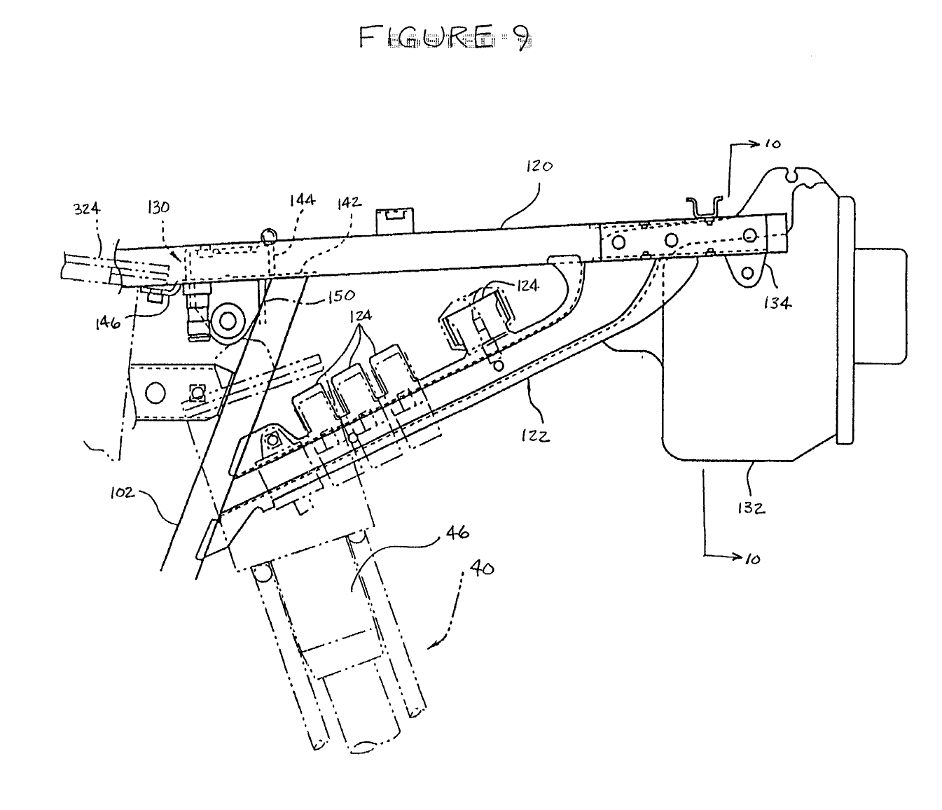

As introduced above, the motor vehicle 30 also has a rear suspension system 40. The rear suspension system 40 generally comprises a swing arm (not shown) which is pivotably connected to the frame assembly 32. In the illustrated embodiment, a shock absorber assembly 46 (see FIG. 9) extends from a mounting position on the rear of the frame assembly 32, discussed in detail below, downward to a bracket (not shown) on the swing arm (not shown). Thus, the movement of the rear wheel 36 relative to the frame assembly 32 is damped and controlled. Because the illustrated suspension systems 38, 40 are well known, no further description of such systems is deemed necessary.

The motor vehicle 30 also includes a body generally comprised of a front fender assembly 48, a rear fender assembly 50, a seat 52 and a fuel tank 54. Each of the body components is carried by the frame assembly 32 and will be described in detail below.

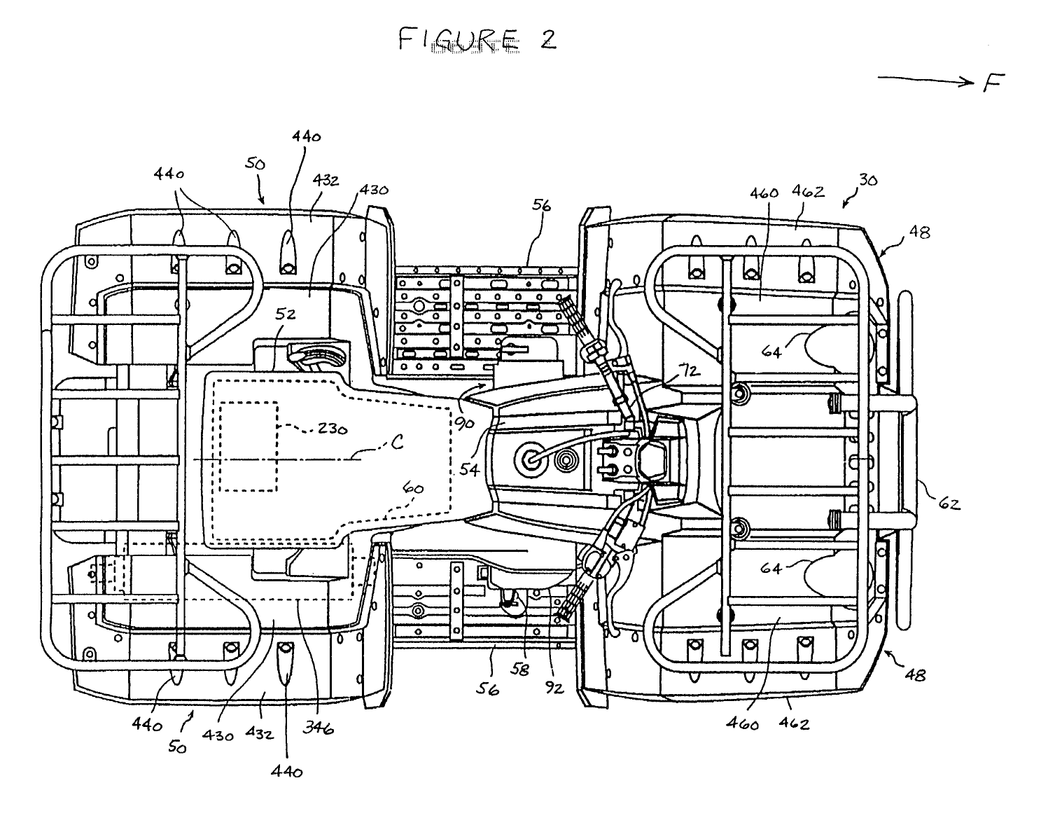

With reference to FIG. 2, a pair of foot boards 56 extend between a portion of the front fender assembly 48 and a portion of the rear fender assembly 50. The foot boards 56 are desirably easily removed from the frame assembly 32 and provide a mounting position for a brake pedal 58. The foot boards 56, the brake pedal 58 and their mounting arrangements will be discussed in detail below.

With continued reference to FIG. 2, the seat 52 preferably accommodates a single rider seated in a straddle fashion (i.e., having one leg on each of the foot boards 56), or a plurality of riders seated in a tandem-straddle fashion (i.e., one behind the other). An access opening 60 can be arranged beneath the seat 52. The seat 52 may be mounted to a removable access opening cover such that the seat 52 may be removed or opened about a hinge to provide easy access to an engine compartment and other components such as, for instance, an air cleaner or the like. Preferably, the seat 52 is affixed to the frame assembly 32 through a locking arm (not shown) with a finger actuator (not shown). For example, the finger actuator (not shown) may be lifted to rotate a pair of hooks (not shown) out of their locking holes (not shown). The seat 52 may then be removed from the frame assembly 32 to reveal the access opening 60.

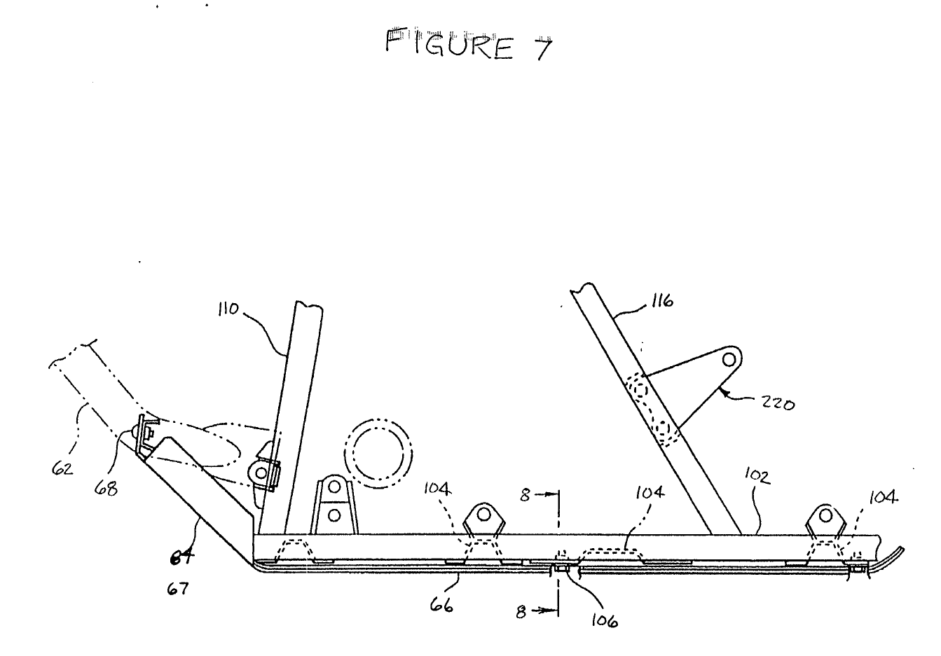

The body of the motor vehicle 30 also includes a front bumper 62, a pair of headlights 64 and an engine guard 66. With reference to FIGS. 2 and 3, the illustrated front bumper 62 extends forward and upward from the frame assembly 32 and wraps over a forward portion of the front fender assembly 48. With reference to FIG. 7, the bumper 62 is preferably attached in any suitable manner to a front end of the frame assembly 32. The illustrated bumper 62 is attached to the front end of the frame assembly 32 via brackets and threaded fasteners. Those of skill in the art will readily recognize that the connections between the front end of the frame assembly 32 and the front bumper 62 can be of any suitable type.

The headlights 64 are preferably nestled behind a forward portion of the front bumper 62 for protection. Additionally, the headlights 64 may be arranged above a pair of outward extensions of the front bumper 62 which further protect the headlights from damage during off-road operation of the motor vehicle 30.

The engine guard 66 may be connected to the frame assembly 32 in a manner described in detail below. A forward end 67 of the illustrated engine guard 66 is removably connected to the front bumper 62 through brackets and threaded fasteners 68. Those of ordinary skill in the art, however, will recognize that the engine guard 66 can be attached to the bumper 62 in any suitable fashion. Preferably, the engine guard 66 serves as a skid plate that allows brush and other obstacles encountered in off-road excursions to be safely passed beneath the frame assembly 32. The illustrated engine guard 66 is desirably removable to allow easy access to the moving components of the drive train and the like for repair and maintenance.

The fuel tank 54 is preferably interposed between a forward end 70 of the seat 46 and a handle bar assembly 72. The handle bar assembly 72 may carry the throttle controls, the choke controls and other operator controls as is known. The illustrated handle bar assembly 72 is connected to a front steering mechanism via a steering column 74. The steering column 74 is pivotably supported at the forward end 70 of the seat 52 by the frame assembly 32. A lower end of the steering column 74 carries a pitman arm (not shown) which is coupled to the carrier hubs (not shown) of the front wheels 34. As the steering column 74 is turned (using the handle bar assembly 72), the pitman arm (not shown) turns and a set of tie rods pull and push the carrier hubs (not shown) accordingly. Thus, the handle bar assembly 72 and steering column 74 operate to steer the front wheels 34.

An internal combustion engine, indicated generally by reference numeral 90, powers the motor vehicle 30. As is known, the internal combustion engine 90 may comprise any of a number of engine configurations. For instance, the engine 90 may operate on the two-stroke principle or the four-stroke principle. The engine 90 may have as few as one cylinder or more than two cylinders. In the illustrated embodiment, the engine 90 is a four-stroke one-cylinder power plant. The engine 90 preferably drives both the front wheels 34 and the rear wheels 36 through a transmission 92 that is discussed in detail below.

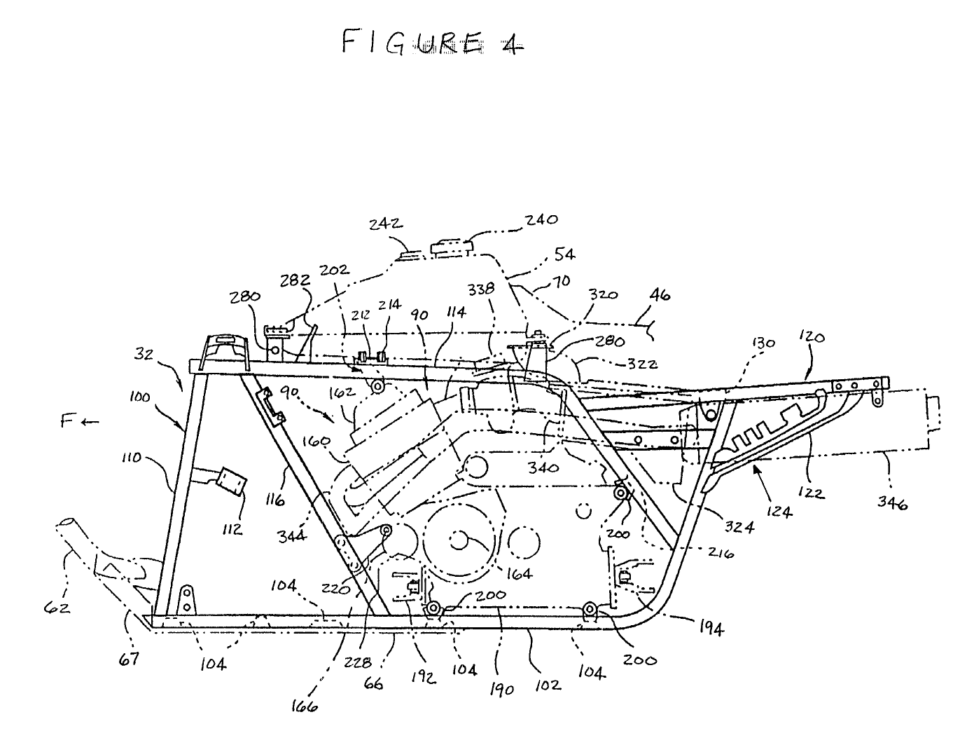

Having introduced the basic structure of the motor vehicle 30, which serves to set forth an exemplary environment in which the present invention may find utility, an embodiment of the present invention will now be described in detail. With reference now to FIG. 4, the frame assembly 32 and its connections to other components of the motor vehicle 30 will be presented. The frame assembly 32 includes a pair of side frames 100 which are joined together by a plurality of members, described below, that extend across the motor vehicle's width in a substantially transverse direction to couple the side frames 100 together.

Each illustrated side frame 100 includes an under pipe 102 which extends horizontally and substantially parallel to the longitudinal centerline C of the motor vehicle 30. The under pipes 102 and a set of cross members 104 preferably define a lower platform of the motor vehicle 30. In the illustrated motor vehicle 30, five cross members 104 extend between the inner portions of the under pipes 102 to define the lower platform.

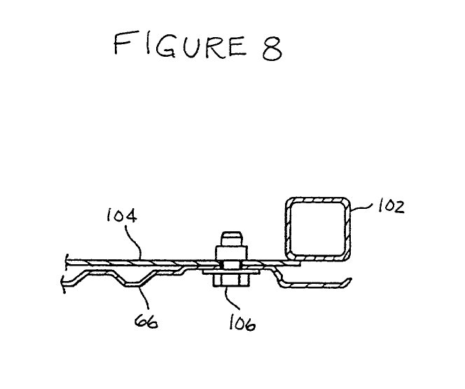

With reference now to FIG. 7, the illustrated engine guard 66, described above, is mounted to the lower platform in a known manner and preferably extends rearward to cover approximately half of the lower platform. Specifically, as illustrated in FIG. 8, threaded fasteners 106 removably attach the engine guard 66 to the cross members 104. As will be recognized by those of skill in the art, the engine guard 66 may also be affixed to the frame assembly 32 in any other suitable manner, such as, for example but without limitation, welds, rivets, interlocking structures, tongue and groove connections and the like.

Desirably, the engine guard 66 extends laterally at least to the inside edges of the frame assembly 32. More preferably, the engine guard 66 extends at least to the outside edges of the frame assembly 32. Longitudinally, the engine guard 66 preferably extends along the lower surface of the lower platform to a location rearward of a front end of the engine 90. More preferably, the engine guard 66 extends rearward of a forward end of a transfer case (discussed below).

The forward end 67 of the engine guard 66 wraps upward toward a lower portion of the front bumper 62. The illustrated engine guard 66 thereby shields an engine compartment defined within the frame assembly 32 from dirt and other debris commonly encountered due to the rough terrain in which the motor vehicle 30 is often operated. The engine guard 66 may be provided with an oil drain hole (not shown) that is arranged such that the engine oil may be changed without removing the engine guard 66 from the frame assembly 32. The oil drain hole (not shown) can also be provided with a removable plug (not shown) which enables the hole to be selectively closed or opened.

Each illustrated side frame 100 also includes a front pipe 110 which extends upward at a rearwardly inclining angle from the forward end of the corresponding under pipe 102. The front pipes 110 preferably form a front end of the frame assembly 32. A support member 112 extends rearward from this front end of the frame assembly 32 and journals the steering column 74 in a known manner generally described above.

Each illustrated front pipe 110 joins with a forward end of a corresponding upper pipe 114. The upper pipes 114 also extend rearward substantially parallel to the longitudinally extending centerline C. With reference to FIG. 4, preferably the upper pipes 114 bend downward at about a most forward portion 70 of the seat 52. Desirably, the rear end of each upper pipe 114 is welded to an upwardly bent portion of the corresponding under pipe 102 at a location between an upper platform defined by the pair of upper pipes 114 and the lower platform.

With continued reference to FIG. 4, a down tube 116 also forms a part of each illustrated side frame 100. The illustrated down tube 116 extends between the corresponding upper pipe 114 and under pipe 102. Preferably, the down tube 116 extends downward at substantially the same angle as the rear portion of the upper pipes 114. However, the down tube 116 need only extend between the upper pipe 114 and the under pipe 102 to form a structurally sound trestlework. Each down tube 116 desirably carries a bracket (discussed below) to which an engine mounting stay (discussed below) can be secured.

Each illustrated side frame 100 also includes a seat support frame that comprises a seat rail 120 and a back stay 122. The seat rail 120 preferably extends rearward of the corresponding upper pipe 114 and is desirably welded thereto. Each seat rail 120 is also secured to the rear end of the rearmost portion of the corresponding under pipe 102 which is bent upward as described above.

The seat rail 120 preferably extends rearward, beyond its connection to the under pipe 102 This rearward extension of the seat rail 120 may be supported by the corresponding back stay 122. The back stay 122 may form a gusset between the seat rail 120 and the under pipe 102 to lend support to the rearmost portion of the seat rail 120. Additionally, the back stays 122 may be provided with a plurality of brackets 124 which allow the mounting of electronics or mechatronic controls, such as, for example, relays and the like. Furthermore, the seat rails 120 may be interconnected by means of a cross brace 130 and other cross members to add further rigidity to the frame assembly 32.

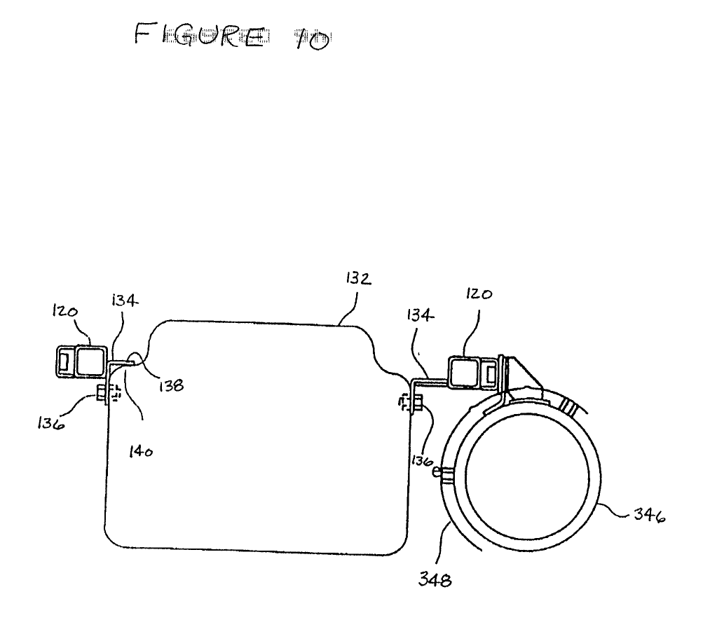

With reference now to FIGS. 9 and 10, a storage box 132 is supported toward the rear end of the illustrated frame assembly 32 between the seat rails 120. The illustrated storage box 132 is hung from the seat rails 120 via a pair of L-shaped box stays 134. The box stays 134 are preferably welded to the inside-facing wall of the seat rail 120 or to a flat bar that extends inward from the inside-facing wall of the seat rail 120. As illustrated in FIG. 10, a plurality of threaded fasteners 136 may be used to attach the box 132 to the box stays 134. The vertical location of the box 132 is defined, in part, by a transverse portion 138 of the box stay 134 which desirably lies upon a leveled recess portion 140 of the box 132.

With reference to FIG. 9, the illustrated cross brace 130 will be described in detail. The cross brace 130 generally comprises a flat bar 142 and a channel 144 that are preferably welded together into a single structural member. As illustrated, the flat bar 142 lies between the lower edges of the seat rails 120. The channel 144 is preferably welded to an upper surface of the flat bar 142 to define the hollow rectangular shape of the illustrated cross brace 130.

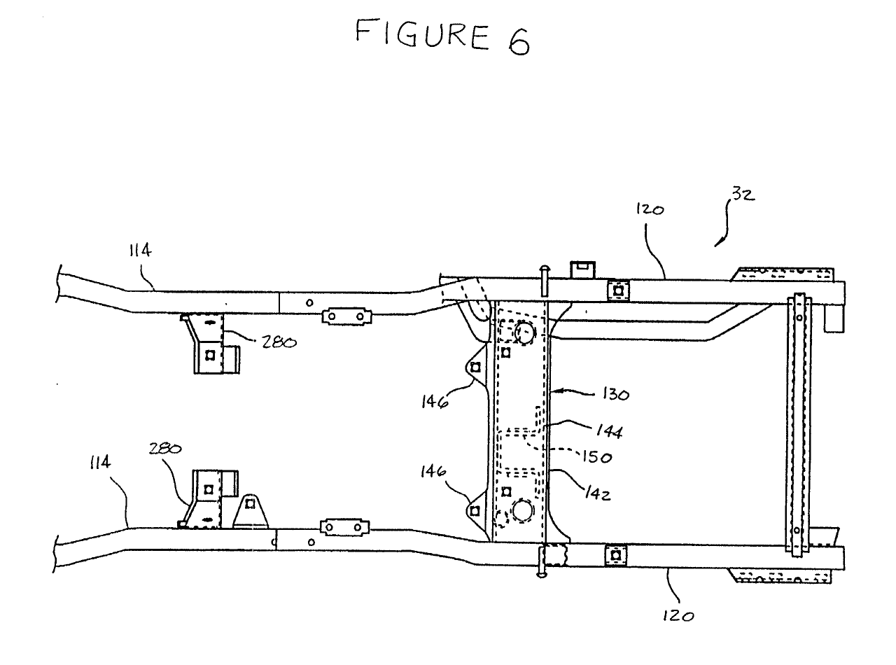

The flat bar 142 desirably has a pair of ears which extend forward from the forward face of the cross brace 130 to define a pair of air cleaner stays 146. With reference to FIG. 6, an air cleaner, described in detail below, may be removably mounted to the air cleaner stays 146 in a known manner. With reference to both FIGS. 6 and 9, a rear suspension mounting bracket 150 may be welded to the lower surface of the flat bar 142. Preferably, the mounting bracket 150 is a flanged channel member; however, any suitable cross-sectional shape may be employed. Advantageously, the mounting bracket 150 is used to secure the upper end of the rear suspension system 40, as described above.

The frame assembly 32 preferably defines an engine compartment in which the engine 90 is mounted. Additionally, as will be appreciated, the frame assembly 32 may include a plurality of mounting brackets that will hereinafter be introduced along with the components that are mounted thereby.

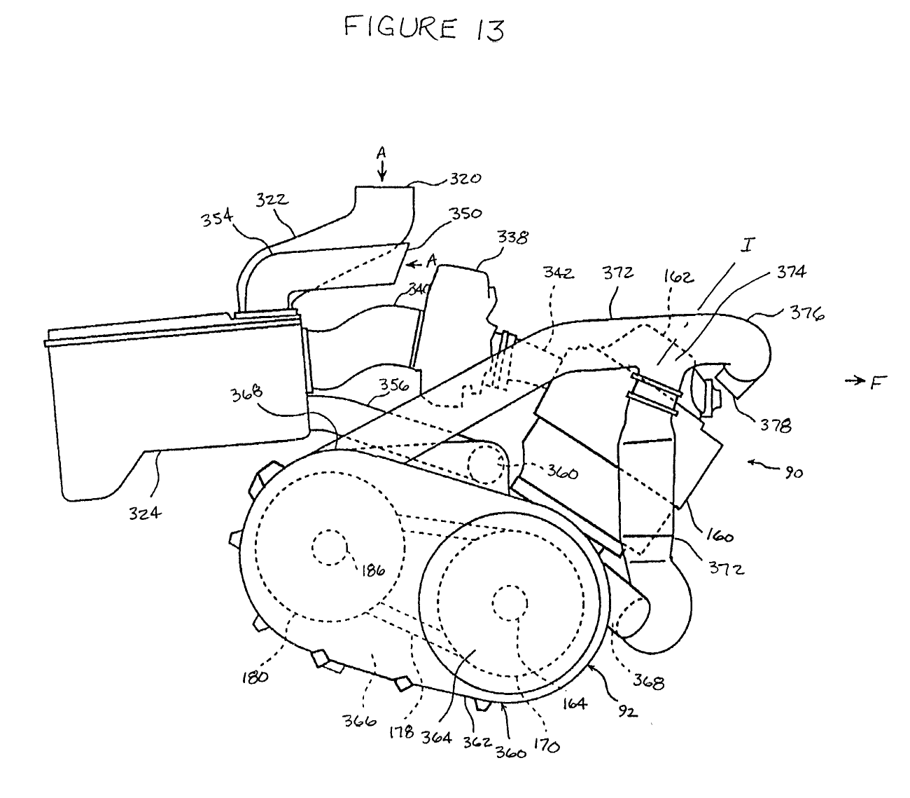

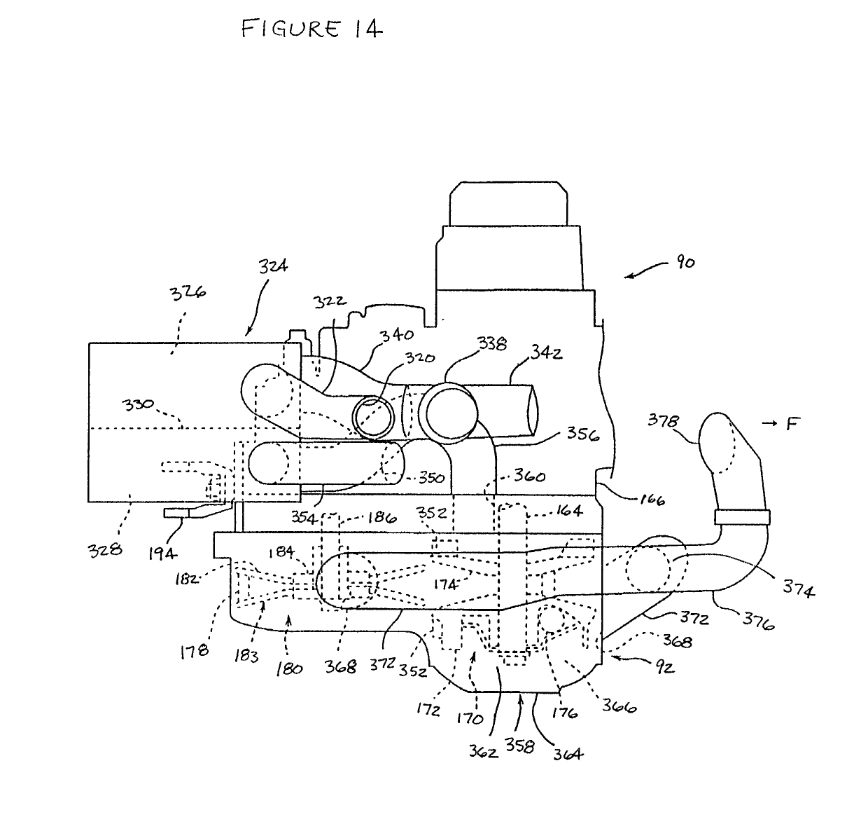

The engine 90 is mounted to the frame assembly 32 within the engine compartment in a manner described below. With reference to FIGS. 13 and 14, the engine 90 generally comprises a cylinder block 160 having a cylinder head 162 connected thereto and cooperating therewith to define one cylinder in the illustrated embodiment. A combustion chamber is defined by a cylinder wall within the cylinder block 160, a recessed area in the cylinder head 162 and a top of a piston (not shown). Preferably, the engine 90 is tilted or inclined so that the combustion chamber (not shown) has an axial centerline I which is offset in a first direction from a vertical axis. This arrangement advantageously keeps the vertical profile of the engine 90 small.

The piston (not shown) is mounted for reciprocation within the cylinder (not shown) and is connected to the throw of a crankshaft 164 via a connecting rod (not shown), as is well known in the art. The crankshaft 164 is constrained for rotational movement within a crankcase 166.

With reference to FIG. 14, the illustrated crankshaft 164 drives a v-belt transmission 92. Preferably, the v-belt transmission 92 includes an input having a primary drive pulley 170. The drive pulley 170 generally comprises a mobile sheave 172 and a fixed sheave 174. The distinction between the two sheaves 172, 174 relates to axial movement: one is axially fixed along the shaft 164 while the other can slide axially along the shaft 164. A weight 176 is provided between the mobile sheave 172 and a wall of a housing or a cover plate or member. As the drive pulley 170 spins, the weight 176 is urged centrifugally outward. As the weight 176 slides outward, away from the shaft 164, the mobile sheave 172 is urged axially along the shaft 164 towards the fixed sheave 174. Because of the complementary angled drive surface of each of the sheaves 172, 174, as the sheaves 172, 174 approach one another, the actual driving portion of the sheaves moves radially outward and the effective diameter of the drive pulley 170 increases.

The drive pulley 170 powers a driven pulley 180 through a v-belt 178. The illustrated driven pulley 180 has an adjustable sheave 182 and a fixed sheave 183 that are biased together by a spring (not shown) into an initial position. The adjustable sheave 182 changes the effective diameter of the driven pulley 180 in a known manner because of the variable sizing of the drive pulley 170. The driven pulley 180 also has a centrifugal clutch 184 that desirably engages to allow engine braking on downhill runs.

The driven pulley 180 in turn drives a transfer input shaft 186. The transfer input shaft 186 extends into a transfer case 190 (see FIG. 4) which may be mounted to the engine 90 below the crankcase 166. Because the illustrated transfer input shaft 186 extends transverse to the longitudinal axis of the motor vehicle 30, a bevel arrangement (not shown) desirably transfers the rotation of the transfer input shaft 186 to the necessary rotation for a forward drive shaft 192 and a rear drive shaft 194 (see FIG. 4). The forward drive shaft 192 selectively drives the front wheels 34 and the rear drive shaft 194 drives the rear wheels 36 in a known manner.

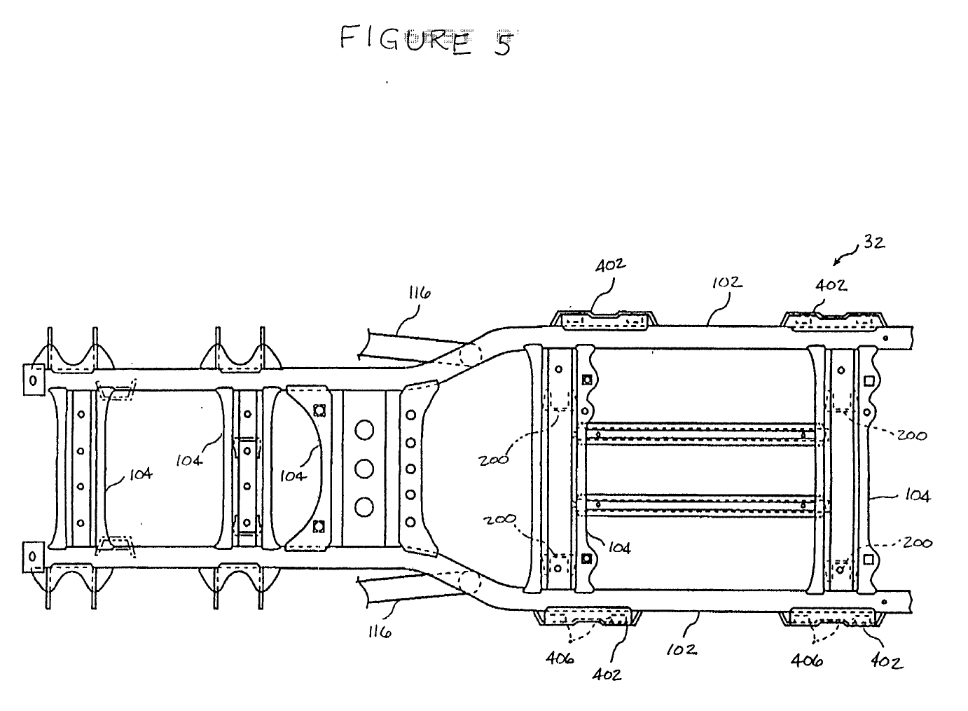

With reference to FIGS. 5, 11 and 12, the illustrated mounting arrangement for the engine 90 and the transfer case 190 will be described in detail. As illustrated in FIG. 5, a plurality of transfer case mounting brackets 200 are provided on the lower cross members 104. The transfer case 190 is preferably attached via threaded fasteners to the transfer case mounting brackets 200 through bosses that extend from the transfer case.

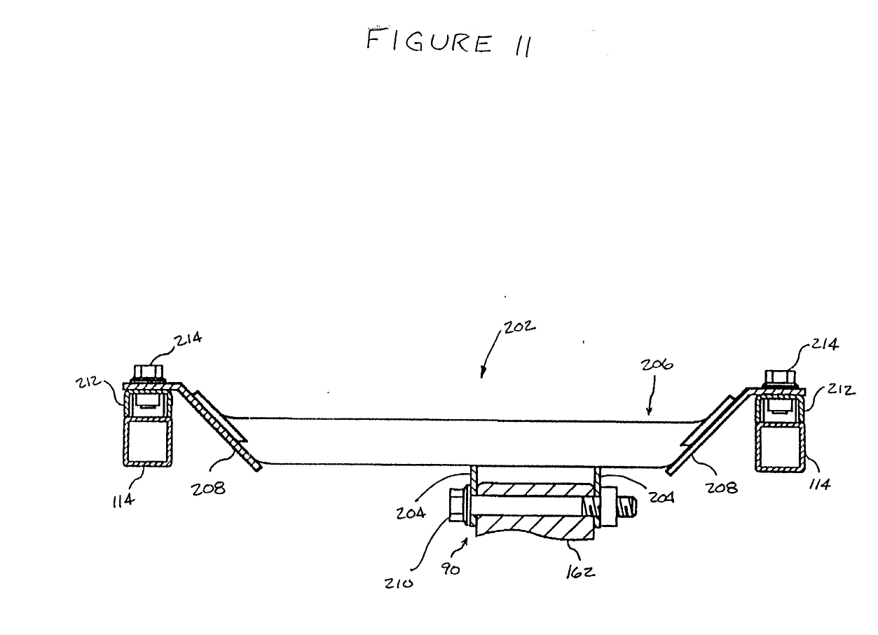

The engine 90, while coupled to the transfer case 190 in any suitable fashion, is also attached to the upper pipes 114 via a cylinder head mounting structure 202. With reference to FIG. 11, the illustrated cylinder head mounting structure 202 generally consists of a pair of hanging ears 204, a cross beam 206 and a pair of flat bar hangers 208. The hanging ears 204 depend from the cross beam 206 and preferably receive a threaded fastener 210. The illustrated cross beam 206 is cylindrical, but need not be. The threaded fastener 210 preferably extends through a mounting boss in the cylinder head 162 to hang the cylinder head 162, and the balance of the engine 90, from the cylinder head mounting structure 202.

The illustrated cross beam 206 is supported by the flat bar hangers 208 which are welded to the ends of the cross beam 206. The hangers 208, in turn, are attached to a pair of brackets 212 that are preferably welded to an upper surface of the upper pipes 114. A set of threaded fasteners 214 may attach the illustrated hangers 208 to the brackets 212. A similar structure 216 may also be provided on the downward bent portion of the upper pipes 114 to hang the upper rear end of the transfer case 190. As will be understood by those of skill in the art, the engine 90 and transfer case 190 can also be mounted to the frame assembly 32 in any suitable manner.

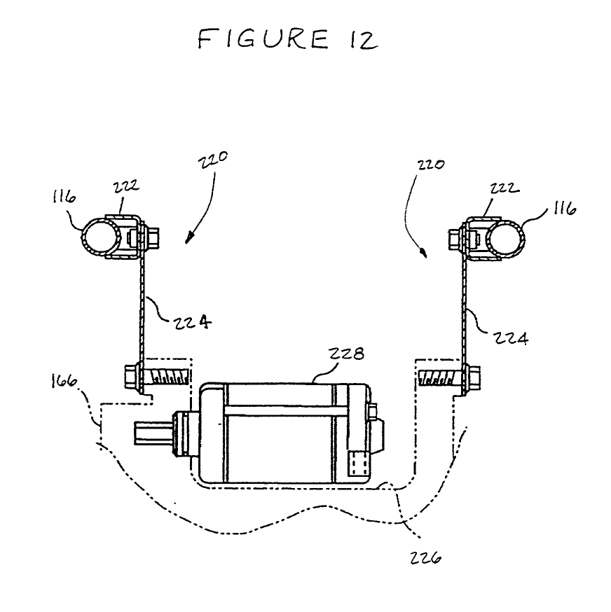

Moreover, the illustrated engine 90 is mounted to the down tubes 116 using a pair of crankcase hangers 220. With reference to FIGS. 4 and 12, the crankcase hangers 220 are mounted to the down tubes 116 at a lower location corresponding to the engine crankcase 166. Specifically, the illustrated crankcase hangers 220 each comprise a bracket 222 which is preferably welded to the corresponding down tube 116 and a flat bar 224. The flat bar 224 extends between the bracket 222 and a corresponding mounting flange. The illustrated flat bar 224 is secured to these two members via threaded fasteners. The mounting flanges define, in part, a recessed portion 226 of the crankcase 166 that houses a starter motor 228.

As is known, the starter motor 228 provides an initial rotation to the crankshaft 164 for ignition. The crankshaft 164 is spun when the starter motor 228 engages a flywheel (not shown) having a starter ring (not shown). The power for the electric starter motor 228, and other accessories, is provided by a battery 230 in a known manner. As will be recognized by those of skill in the art, a generator (not shown) can also be used to continue to provide electrical power to the engine and accessories after ignition. The battery 230 is contained within a battery box. The battery box in the illustrated embodiment is located between and above the rear wheels 36.

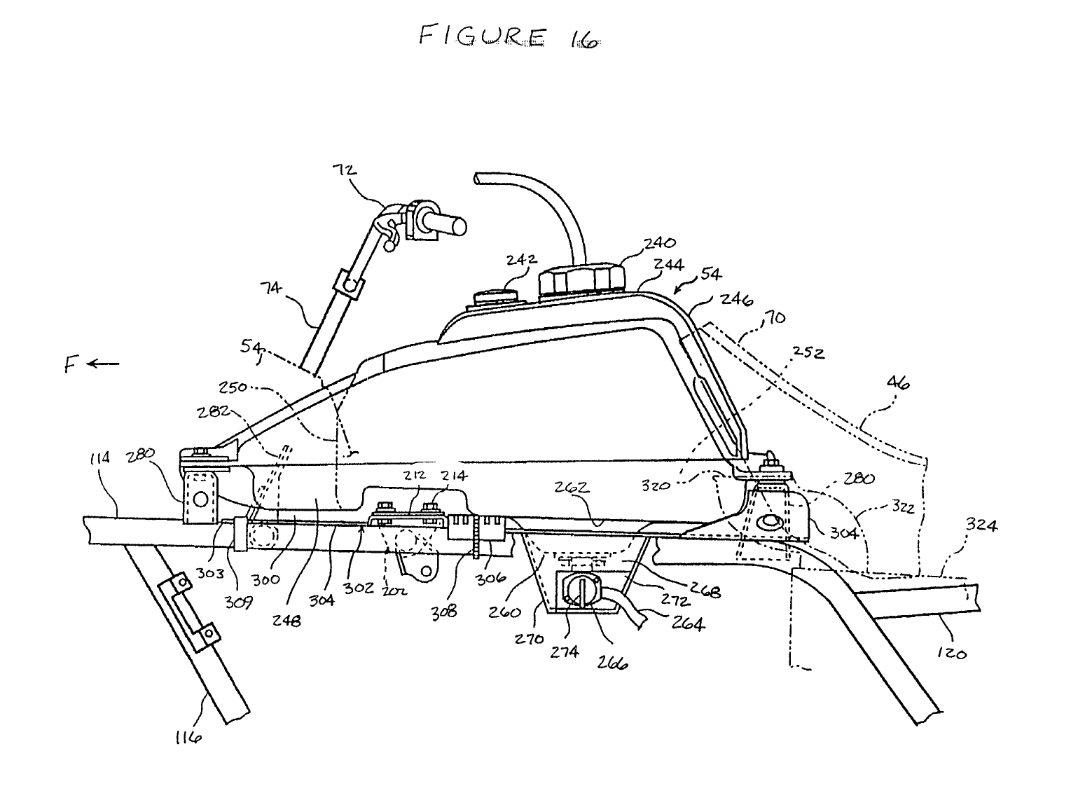

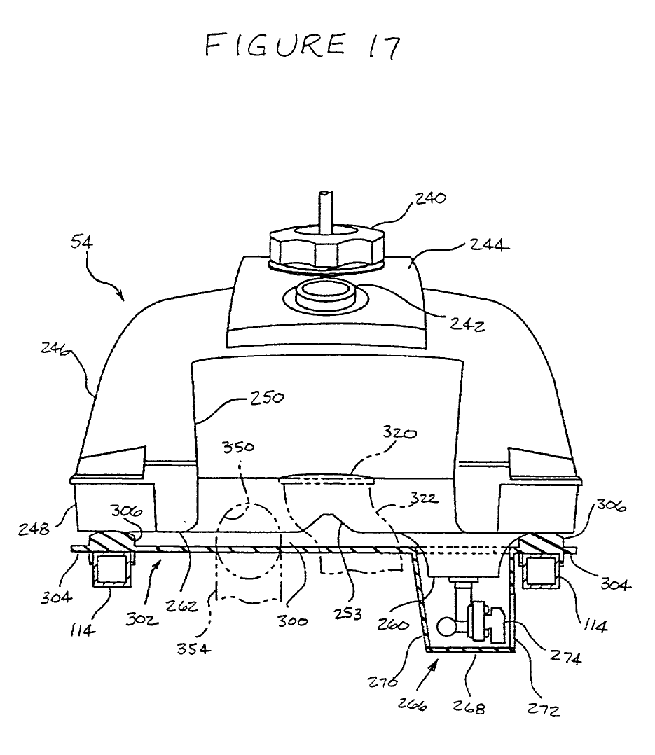

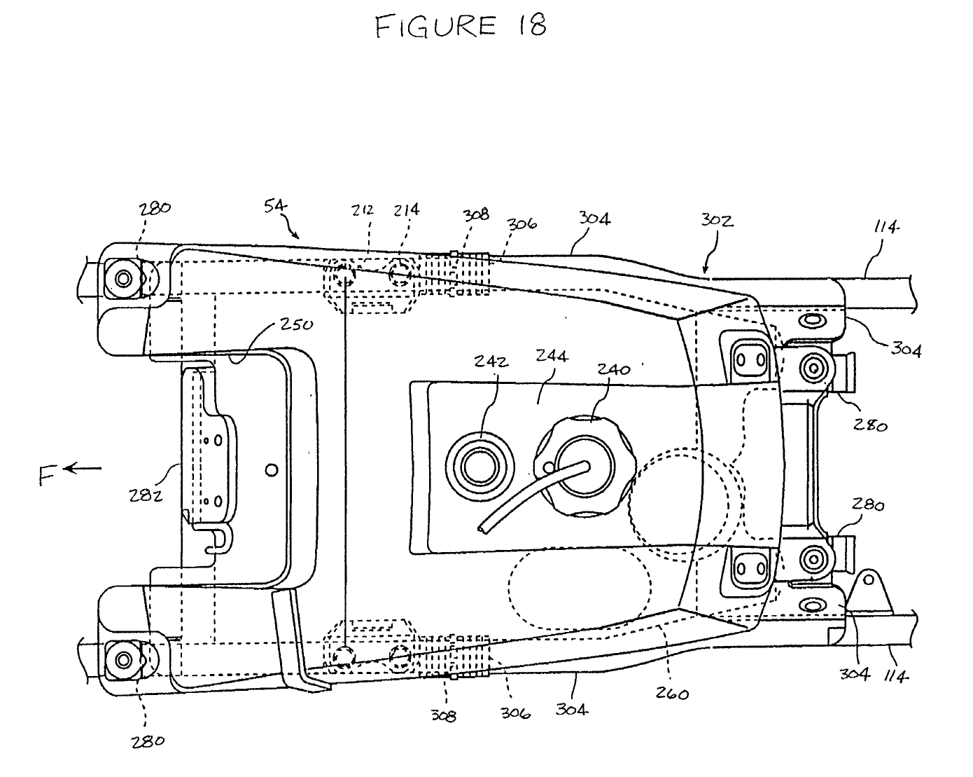

With reference to FIGS. 16-18, the fuel tank 54 will now be described in detail. The fuel tank 54 is preferably plastic to reduce weight and manufacturing costs, but may also be manufactured from any other suitable material. As illustrated, the fuel tank 54 is provided with a fuel cap 240 and a fuel gage 242. Both are preferably arranged on an upper portion 244 of the fuel tank 54, but need not be, and both are well known to those of skill in the art. The fuel tank 54 also comprises an upper tank 246 and a lower tank 248. The lower tank 248 and the upper tank 246 define a generally U-shaped structure with a central longitudinal recess 250 defined in a front portion of the tank 54. To the rear of the fuel tank 54, a second recess, an air collector chamber 252, is defined under the fuel tank 54. Moreover, a longitudinally extending groove 253 is defined which desirably extends the length of the fuel tank 54. The groove 253 advantageously increases the volume of air that may be drawn through an air passage, which will be discussed below.

The illustrated fuel tank 54 has a fuel pool 260 that depends from the lower tank 248 at substantially the same longitudinal position as the fuel cap 240. Desirably, the fuel pool 260 is arranged to be vertically lower than a lower surface 262 of the fuel tank 54. The illustrated fuel pool 260 defines the lowest level of the fuel tank 54 and is the location at which fuel is drawn from the fuel tank 54 for supply to the carburetor of the engine 90.

The fuel is drawn from the fuel tank 54 through a fuel supply line 264. A fuel cock 266 may be interposed between the fuel pool 260 and the fuel supply line 264 to allow the flow of fuel therethrough to be manually terminated or controlled. The illustrated fuel cock 266 is contained within a housing 268 that is desirably formed by heat resistant walls 270. The heat resistant walls 270 advantageously aid in reducing vaporization of the fuel that is contained within the fuel supply line 264 and the fuel cock 266. The heat resistant walls 270 may be integrally formed (i.e., one-piece construction) with a guide plate which will be introduced below. The housing 268 preferably has a cut-out 272 through which a lever 274 of the fuel cock 266 extends. The illustrated fuel cock lever 274 can be rotated clockwise or counterclockwise to open or close the fuel cock 266 and start or stop the flow of fuel as necessary.

The illustrated fuel tank 54 is mounted to the upper pipes 114. Brackets 280 are preferably welded to the upper pipes 114 to which the fuel tank 54 is mounted using threaded fasteners. Additionally, a support bracket 282 extends up into the central longitudinal recess 250 in the front portion of the fuel tank. The support bracket 282 lends added longitudinal support and stability to the steering column 74.

With reference to FIGS. 13-17, the illustrated engine 90 is provided with an air induction system having features in accordance with one aspect of the present invention. The air induction system advantageously draws air from the oncoming rush of air during forward motion of the motor vehicle 30. Specifically, as illustrated in FIG. 16, air is forced through a longitudinal air passage 300 defined between the bottom surface 262 of the fuel tank 54 and a guide plate 302. As will be recognized, air may also be drawn through the air passage 300 while the vehicle is not moving

The guide plate 302 is desirably formed of a rubber or plastic material to reduce weight and simplify manufacturing. Preferably, the guide plate 302 extends substantially the length of the fuel tank 54. The illustrated guide plate 302 has a pair of side rims 304 that lie to the outside of mounting channels which slip onto the upper pipes 114. With reference to FIG. 16, the rims 304 may extend upward to the sides of the fuel tank 54 near a rear portion of the fuel tank 54. As will be described, this upward extension will help to direct the air flow into the air intake system. The side rims 304 may be flush with the balance of the body of the guide plate 302 or may be raised above the interior portion of the guide plate 302. If the interior portion of the guide plate 302 is recessed relative to the side rims 304, the amount of air pulled through the air passage 300 may be increased. Advantageously, the guide plate 302 may be configured to receive a filter such that the air flowing through the passage 300 can be pre-filtered prior to introduction into the induction system.

The illustrated side rims 304 also lie to the outside edges of a raised ridge 306 upon which the fuel tank 54 may rest. With reference to FIG. 16, the raised ridge 306 can be positioned at approximately the middle of the length of the fuel tank 54 to provide support to this portion of the fuel tank 54. The raised ridge 306, however, may also extend the entire length of the guide plate 302 to result in an enclosed air passage 300. In the illustrated guide plate 302, the raised ridge 306 is integrally formed (i.e., one piece construction) with the side rims 304 of the guide plate 302. A band element 308 may be wrapped around the raised ridge 306 to secure the guide plate 302 or raised ridge 306, when separate from the guide plate 302, to the upper pipes 114. In some embodiments, the band element 308 may be separate from the fuel tank 54, while in other embodiments; the band element 308 is an extension of the lower surface 262 of the fuel tank 54. The illustrated guide plate 302 is secured to the upper pipes 114 by a C-clip 309 at a front end 303 of the guide plate 302. Other fastening arrangements, such as fasteners, threaded members and interlocking structures are also contemplated for attaching the fuel tank 54 to the guide plate 302 and the guide plate 302 to the upper pipes 114. Desirably, the raised ridge 210 may be constructed to reduce the transmission of vibrations from the frame assembly 32 to the fuel tank 48 (i.e., molded from a resilient material).

An air induction system inlet port 320 is positioned within the illustrated air collector chamber 252 defined in the lower surface 262 of the fuel tank 54. In this position, the inlet port 320 is elevated to approximately the level of the seat 52 on which an operator is positioned during use. Additionally, because the inlet port 320 is positioned within the air collector chamber 252 of the lower surface 262 of the fuel tank 54, the inlet port 320 is shielded from a majority of the dirt, dust and debris often encountered by the motor vehicle 30 in its field of use. As is known, the air inlet port 320 can also be provided with a semi-circular cap (not shown) that controls air pulses and back flow and improves engine performance.

The air enters an air induction intake duct 322 through the inlet port 320. The illustrated intake duct 322 is bent in a shallow S-shape to transfer air from the inlet port 320 to an air box 324 which is mounted at a lower elevation relative to the inlet port 320 and to the rear of the inlet port 320. With reference to FIGS. 4 and 9, the illustrated air box 324 is mounted to the cross brace 130, which is located between the seat rails 120.

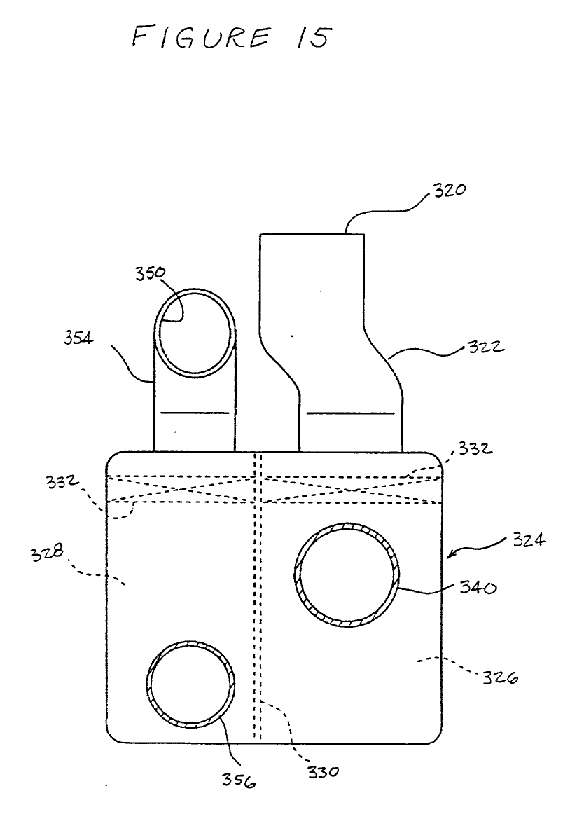

Desirably the air box 324 is an air cleaner which cleans the air flowing therethrough. With reference now to FIGS. 14 and 15, the illustrated air box 324 is divided into two portions: an air intake portion 326 and a cooling air portion 328. The cooling air portion 328 will be discussed in detail below. A dividing wall 330 defines the split portions 326, 328. Both portions 326, 328 may also contain a filter element 332 that is design to reduce the influx of solid foreign particles along with the air stream. Any suitable filter element may be used.

After passing through the illustrated air intake portion 326 of the air box 324, the air then flows forward into a carburetor 338 through an intake transfer duct 340. Within the carburetor 340, the air is mixed with fuel in a known manner. As will be recognized, the present invention, while illustrated with a carbureted engine, may also find utility with a fuel-injected engine (i.e., either indirect injection into the air stream or direct injection into the cylinder or combustion chamber). The air-fuel charge is then provided to the cylinder through an intake pipe 342.

Within the cylinder, the air-fuel charge is supplied to a combustion chamber for ignition in a known manner. Following combustion, the spent gases may be exhausted to the atmosphere through an exhaust pipe 344 and an exhaust silencer 346 generally as illustrated in FIG. 4. With reference to FIG. 10, the exhaust silencer 346 is preferably mounted to a seat rail 120 and may be provided with a heat shield 348 to protect the storage box 132 from the extreme heat generated by the exhaust gases flowing through the silencer 346.

As discussed above, the illustrated air box 324 is dual chambered: one chamber services the induction system (introduced above) while the other chamber services a cooling air system which will now be discussed. The cooling air system provides cooling air to the transmission 92. As will be recognized by those of skill in the art, the V-belt variable transmission 92 generates heat as the drive pulley 170 expands and contracts and the speed of the belt 178 increases and decreases. Accordingly, cooling air is introduced into the transmission casing to reduce the level of heat build up around the belt drive unit.

The illustrated cooling system draws its air from the air passage 300 through a cooling air inlet port 350 due, in part, to an arrangement of fan blades 352 on both of the sheaves 172, 174 of the drive pulley 170. The cooling air inlet port 350 is preferably forward facing and at a lower vertical height than the inlet port 320 of the induction system. While the concern for water-free air may not be as great for the cooling air system, the disclosed embodiment is desirably sealed and arranged to maximize water preclusion from the belt chamber as discussed below. Additionally, the differing directions for the intake ports of both the induction and cooling air systems is also desirable due to the differing degrees of suction at which the air is pulled into each (i.e., a negative pressure differential between the induction and cooling air systems). Therefore, air is channeled into the cooling air system through the air passage 300 directly into the forward facing inlet port 350.

The air preferably flows through the port 350 into a cooling air intake duct 354. The cooling air then enters the cooling air portion of the illustrated air box 324 through the filter element 332.

Having flowed through the cooling air portion 328 of the illustrated air box 324, the cooling air may then be channeled through a cooling air guide-in duct 356. The guide-in duct 356 may terminate at an inlet port 360 in a V-belt case 360. The illustrated V-belt case 360 is generally defined by a peripheral wall 362 and a pair of substantially parallel side walls 364.

A belt chamber 366 is defined by the illustrated V-belt case 358. Upon entering the belt chamber 366, the air may be circulated by the motion of the pulleys 170, 180, their fan blades 352 and the belt 178. The air reduces the temperature within the belt chamber 366 by absorbing some of the heat being generated and passing from the belt chamber 366 through a pair of cooling air outlet ports 368. The illustrated belt chamber 366 is provided with two cooling air outlet ports 368 due to the thermal expansion of the cooling air within the chamber. As will be recognized by those of skill in the art, more than one air inlet 360 and more or less than two air outlets 368 may also be provided to serve the same purpose of cooling the belt drive transmission 92.

With reference to FIGS. 13 and 14, the illustrated arrangement of the inlet 360 and outlet 368 ports is desirably configured to aid the flow of air that is stirred by the fan blades 352. For instance, the illustrated inlet port 360 is strategically placed near a central region of the belt chamber 366. The outlet ports 368 are desirably arranged such that one is near the driven pulley 180 and one is near the drive pulley 170. Accordingly, air flows past both before exiting the belt chamber 366. Additionally, due to the direction of rotation of the illustrated crankshaft (i.e., clockwise), the air may be circulated throughout the chamber 366 before exiting. Furthermore, upon exiting, the air may be discharged from the outlet port 368 that faces rearward. This orientation tends to draw the air from the discharge port while the motor vehicle 30 is in motion. Accordingly, the configuration of the illustrated air cooling system results in improved cooling with cleaner air and better flow patterns.

The heated air is ushered away from the illustrated belt chamber 366 by a manifold system having two pipes 372 extending upward and away from the cooling air outlet ports 368. The two pipes 372 preferably merge at a merge point 374 and extend as a single pipe 376 to a discharge port 378.

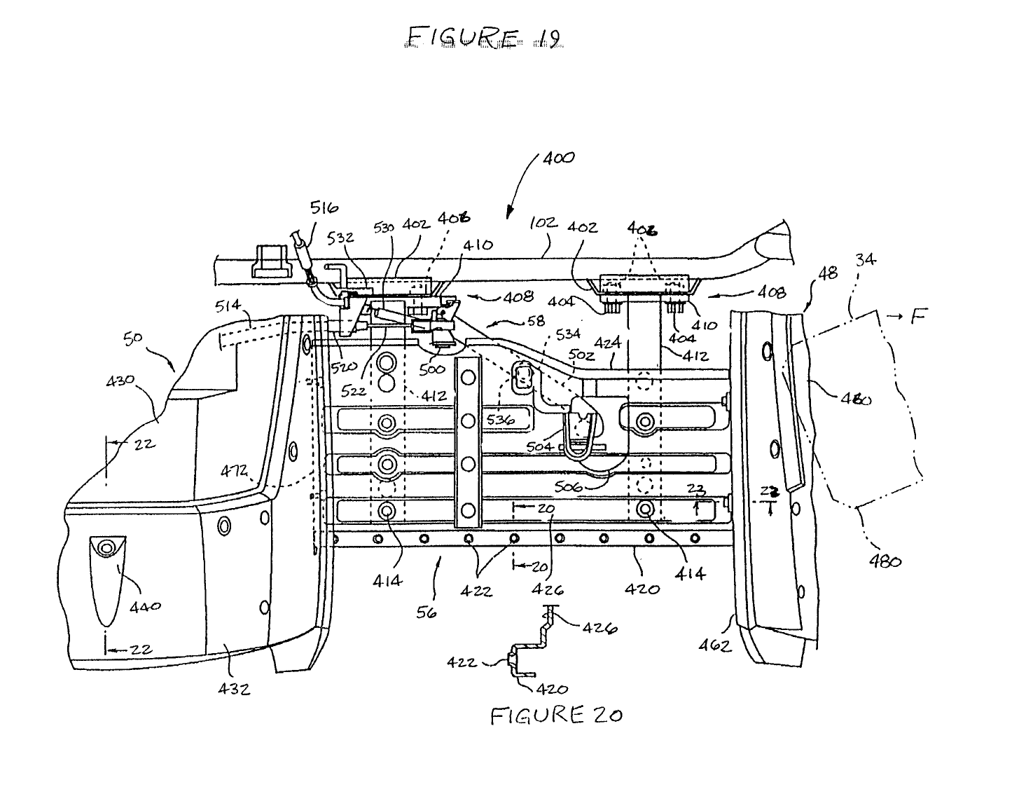

With reference now to FIGS. 19-23, an arrangement 400 of the foot board 56 and the brake pedal 58 will be described in detail. As will be recognized, each motor vehicle 30 desirably has a pair of foot boards 56 (i.e., one on each side); however, it is contemplated that a single structure can extend to both sides of the motor vehicle 30 and be attached in the described manner.

As best illustrated in FIGS. 5 and 21, the illustrated arrangement 400 generally comprises removably mounting the foot board 56 to the frame assembly 32 via a plurality of foot board mounting brackets 402. The illustrated mounting arrangement comprises a pair of foot board mounting brackets 402 which are welded to the under pipe 102 and extend slightly outward therefrom. A plurality of threaded fastener sets such as, for example but without limitation, bolts 404 which thread into weld nuts 406 welded to the mounting brackets 402, removably secure the mounting fixtures 408 to the frame assembly 32. As will be recognized by those of ordinary skill in the art, any of a number of arrangements may be used to secure the fixtures 408 to the frame assembly 32.

The illustrated foot boards 56 are removably secured atop the mounting fixtures 408. The fixtures 408 are generally comprised of a mounting tab 410 and a cantilevered arm 412, which are welded together. The illustrated arms 412 are formed from square tubing while the illustrated mounting tab 410 is a stub-T shaped piece of flat stock having a pair of through holes located along the cross bar portion. The bolts 404, described above, attach the mounting fixtures 408, via the mounting tabs 410, to the brackets 402. A plurality of fasteners 414, in turn, attach the foot board 56 to the mounting fixtures 408.

While the foot board 56 may also be welded to the mounting fixtures, or the mounting fixtures may be welded to the frame assembly, such configurations reduce the ease with which any damaged components may be swapped out of the assembly 400. For instance, rocks and the like are often thrown into the foot board region of the motor vehicle 30 and result in damage to the foot board assembly 400. The present invention, therefore, utilizes easily exchanged components to reduce repair costs.

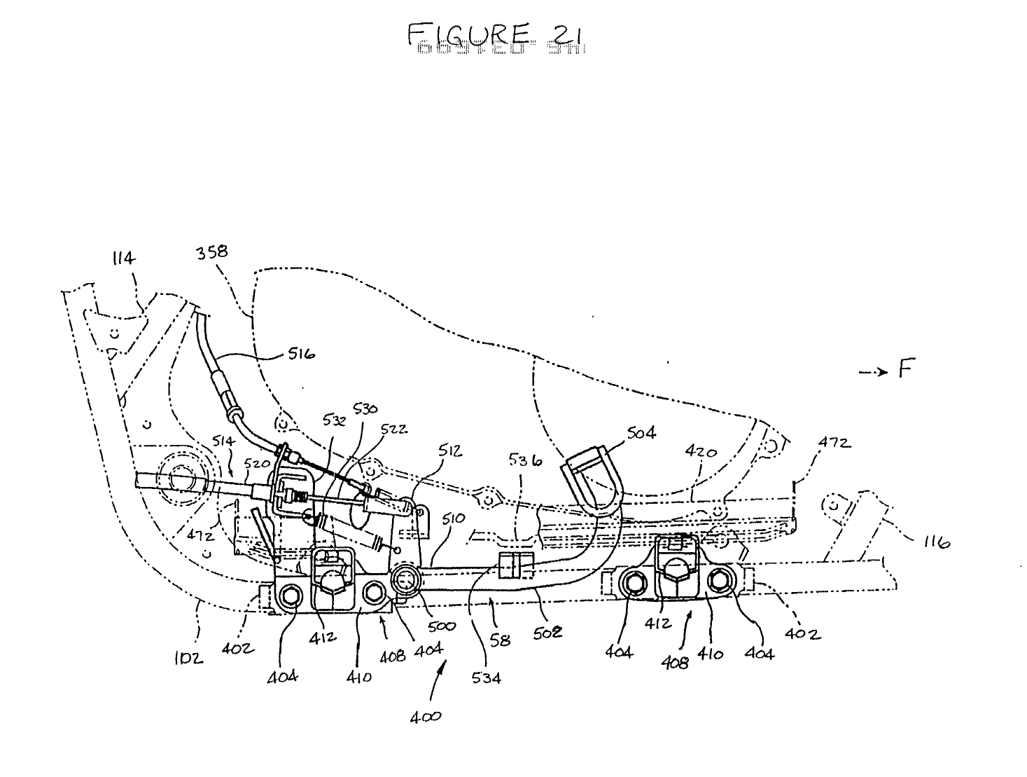

Because of the soggy environments often encountered by operators of the motor vehicle 30, the illustrated foot boards 56 are desirably provided with ridges and slip-resistant burring patterns. Notably, a variety of other non-slip textures and surface finishes can also be used. With reference to FIG. 20, a cross section through the external edge of the foot board 56 is illustrated. The outer extremity of the illustrated foot board 56 has a raised reinforcing ridge 420 with an upper surface having a line of burrs 422. The inner extremity of the illustrated foot board 56 also has a reinforcing beading 424. Both the reinforcing ridge 420 and the reinforcing beading 424 add structural strength to the foot board 56 as well as defining a recessed central region 426 which aids the rider in maintaining their footing on the foot boards 56.

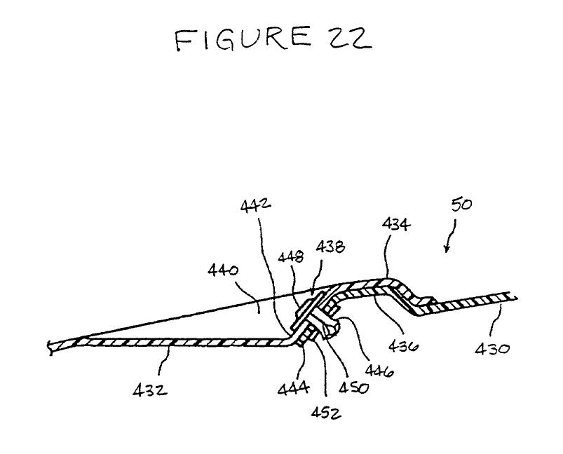

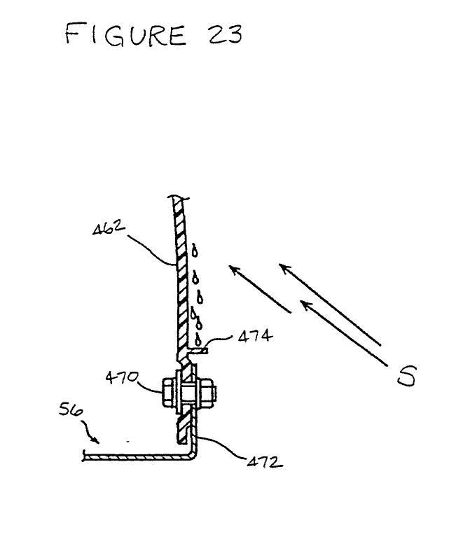

The front and rear ends of the foot boards 56 are also secured to the adjacent fender assemblies 48,50. With reference to FIG. 22, a section through an exemplary rear fender assembly 50 is illustrated. Generally, the fender assemblies are comprised of a fender and an overfender. Specifically, the illustrated rear fender assembly 50 is comprised of a rear fender 430 and a rear overfender 432. The overfender 432 has a raised lip 434 which overlaps a corresponding raised lip 436 of the fender 430. Because the overfender 432 is desirably a pliable material, such as, for example but without limitation, a rubber or plastic, and because the overfender is therefore subject to tearing, gouging, ripping or the like, it is desirably removably affixed to the fender 430. Accordingly, a series of rivets 438 secure the two raised lips 434, 436 together in the illustrated embodiment. As illustrated in FIG. 22, the rivet 438 extends into a recessed portion 440 of the overfender 432, and extends through a wall 442, 444 in both lips 434, 436 respectively. Specifically, the rivet 438 desirably extends through the walls 442, 444 in a direction generally normal to both walls 442, 444. As is known, the rivet 438 has a body portion 446 and a head portion 448. In the illustrated arrangement, the body portion 446 is the portion that extends through the walls 442, 444 and has a slit 450. A washer 452 helps to secure the rivet 438 in position and helps to securely fasten the overfender 432 to the fender 430. Other suitable methods of attaching the fender and overfender together, such as threaded fasteners and snapping members, for instance, also may be used. The front fender assembly 48 is similarly constructed of a fender 460 and an overfender 462 which are joined together.

With reference now to FIG. 23, the foot boards 56 are attached to the overfenders 432, 462 through removable fasteners 470. As discussed above, the foot boards 56 are desirably removably attached to the motor vehicle 30 for easy maintenance. Accordingly, to accommodate dimensional variations between replacement parts, the foot boards 56 are attached to the more flexible overfenders 432, 462. The footboards may, in some embodiments, also be affixed to the fenders, or to both the fenders and overfenders. Because of the pliable nature of the overfender 432, 462 dimensional tolerancing of the foot board 56 is not as crucial as compared to solely mounting the foot board 56 to a more rigid structural member, such as the fender 430, 460.

As illustrated in FIG. 23, the foot board 56 has a front and rear flange 472, both of which extend substantially perpendicular to the recessed central region 440 of the foot board 56. The illustrated flange 472 is secured to the overfender 432, 462 at a location below a drip edge 474 via the fastener 470 in a known manner. The drip edge 474 is a narrow rib which redirects condensing tire spray S, which runs down the inside of the overfender 432, 462, away from the fastener 470. It is anticipated that the fastener 470 may be partially shielded from the elements by the drip edge 474. It is also envisioned that a protective cap, stripping or channel may be used to shield the fastener component between the wheel and the overfender from the elements. Moreover, a weldnut or other member which is not open to the wheel may also be used.

With reference to FIG. 19, the front wheel 34 is shown in a full turning position. Desirably, the outer extremity of the foot board 56 extends beyond the outermost rim portion 480 of the front wheel 34 in this orientation. Specifically, a substantially longitudinal vertical plane may be defined through the outermost point on the fully turned rim such that an outer extremity of the footboard 56 is to one side of the plane and the seat 52 of the motor vehicle 30 is to the other side. In this way, the foot board 56 acts as a side guard. Notably, the tire 34 is resilient and the front overfender 462 is pliable. Accordingly, when negotiating a turn, no rigid structural member extends out to the sides of the motor vehicle 30 beyond the rims of the front tires 34 to the exception of the foot boards 56. Thus, the foot boards protect the legs of the operator and any passengers as well as protecting other rigid components of the motor vehicle 30, such as the fenders 430, 460. Additionally, the operator may be shielded from mud and rocks thrown by the tires during use because of the connected foot boards and fender assemblies which extend outward beyond the rims and from front fender to rear fender.

Because the foot board 56 is desirably replaceable, the brake pedal 58 is preferably not affixed to the foot board 56 itself. With reference to FIGS. 19 and 21, a presently preferred mounting arrangement for the brake pedal 58 is illustrated. As best illustrated in FIG. 21, a support shaft 500 extends laterally outward from the mounting tab 410 of the rear mounting fixture 408. The illustrated brake pedal 58 is journaled about the support shaft 500 by bearings or other suitable members. Thus, no separate support structure for the brake pedal 58 is required. This arrangement therefore reduces manufacturing costs.

The illustrated brake pedal 58 generally comprises a forwardly extending pedal arm 502 that turns upward and rearward to connect to a brake step pad 504. As best illustrated in FIG. 19, the pedal arm 502 also extends laterally to locate the step pad 504 in a comfortable position for the rider. The step pad 504 desirably extends upward through a brake pedal aperture 506 in the foot board 56. The aperture 506 may be sized and configured to accommodate the necessary movement of the brake pedal 58.

As mentioned above, the rear end of the illustrated pedal arm 502 is journaled about the support shaft 500 at a base portion 510. The base portion 510 of the illustrated pedal arm 502 also comprises an integral actuator arm portion 512. As will be recognized by those of skill in the art, the actuator arm portion 512 can also be a separate component which is locked to the pedal arm 502 in any suitable manner to allow the two to move together or to allow one to influence the movement of the other.

Preferably, the actuator arm portion 512 controls longitudinal movement of a pair of brake control wires 514, 516. The illustrated wires 514, 516 are desirably a shielded wire, such as, for example but without limitation, a Bowden wire, but can be any other suitable brake actuating arrangement. A rear brake control cable 514 is generally comprised of an outer tube 520 and an inner wire 522. The inner wire 522 is translatable within the outer tube 520. As is known, the movement of the inner wire 522 actuates a braking element (not shown) within the hub (not shown) of the rear wheels 36. A front brake control cable 516 may also extend between the actuator arm portion 512 and a front braking system (not shown). The front brake control cable 516 is preferably constructed in a similar fashion to the rear brake control cable 514.

Depressing the brake pedal arm 502 by stepping on the brake step pad 504 may result in a rotation of the brake pedal arm base 510 about the support shaft 500. This rotational movement preferably pulls the connected actuator arm portion 512 clockwise about the support shaft 500. Accordingly, the inner wires of the front and rear brake control cables 514, 516 may be pulled through the outer sleeves. Desirably, this action activates the brakes (not shown) in a known manner.

The illustrated actuator arm portion 512 also has a biasing member 530. In the illustrated braking pedal arrangement, the biasing member 530 is a compression spring that extends between the actuator arm portion 512 and a support member 532. It is contemplated that other biasing members, such as, for example but without limitation, a torsion spring, elastomeric members, leaf springs and the like may also be used. The biasing action of the biasing member 530 advantageously resists the movement of the actuator arm portion 512 when the brake pedal arm 502 is depressed. Accordingly, when the illustrated brake pedal arm 502 is released, the biasing member 530 urges the actuator arm portion 512 and the attached pedal arm 502 to their original positions. In this position, the brakes are deactivated in a known manner as the inner wires slide back into the outer sleeves and resume their initial positions.

As will be appreciated by those of skill in the art, the forceful return of the pedal arm 502 to its initial biased position by the biasing member 530 may result in a sudden metal-to-metal contact. To reduce wear on the pedal arm 502, and to soften the impact between these components, a resilient stopper member 534 may be provided at a desired location along the pedal arm 502. The illustrated stopper member 534 is affixed to the pedal arm 502 at approximately the same location as a recessed portion 536 of the foot board member 56. The recessed portion 536 defines, in part, a return position of the brake pedal 58. Additionally, the size of the stopper member 534, i.e., the extent to which it extends above the pedal arm 502, may also contribute to this ultimate return position. It is contemplated that the stopper member 534 may also be affixed to the foot board 56. In this situation, the pedal arm 502 may simply strike the stopper member 534 and come to rest, with or without minor rebounds, depending upon the resilient material from which the stopper member 534 is manufactured.

Advantageously, the motor vehicle 30, described above, exhibits superior performance over other earlier four wheel off-road motor vehicles. The arrangement of the intake system within a recess of the fuel tank allows the air to be drawn from a higher location than ordinary. In addition, the provision of the guide plate creates an air passage that may help to exclude dirt and other foreign debris from the intake system. The implementation of an air cleaner within the cooling air system advantageously removes dirt and debris from the belt drive cooling system. This, in turn, may result in longer life for the belt and the pulleys.

The provision of the removable and interchangeable foot boards also allows the operator to perform inexpensive body repairs to one of the most frequently damaged body components. Moreover, the outward extension of the reinforced foot boards provides added security of the operator that less-interchangeable components will be somewhat protected from damage. Furthermore, because the brake pedal is not affixed to the foot boards, the changing of the foot boards will not affect the braking of the motor vehicle. Moreover, because the foot boards are removable, the foot boards can be removed for shipping and installed or reinstalled on location to ease the transportation of the motor vehicles 30. It is also anticipated that the foot boards can be individually electroplated and therefore the electroplating tub size can be reduced. Accordingly, removable foot boards have several distinct advantages over permanently affixed foot boards.

Although this invention has been described in terms of a certain embodiment, other embodiments apparent to those of ordinary skill in the art also are within the scope of this invention. Thus, various changes and modifications may be made without departing from the spirit and scope of the invention. Accordingly, the scope of the invention is intended to be defined only by the claims that follow.

What is claimed is:

1. An all-terrain vehicle comprising a frame assembly, a pair of front wheels and a pair of rear wheels mounted to the frame assembly, a seat arranged behind the pair of front wheels, a plurality of mounting brackets attached to the frame assembly between the front wheels and the rear wheels, the mounting brackets arranged below a portion of the seat, a foot board removably attached to the brackets, a pair of front overfender members and a pair of rear overfender members, wherein the overfender members are pliant and wherein the foot boards are removably connected to the overfender members.

2. The all-terrain vehicle of claim 1 further comprising a brake pedal, wherein the brake pedal is pivotally supported by at least one of the mounting brackets.

3. The all-terrain vehicle of claim 2 wherein the foot boards are attached to the overfender members with a plurality of threaded fasteners.

4. The all-terrain vehicle of claim 3 wherein the overfender members each have a drip edge arranged to lie above the threaded fasteners.

5. The all-terrain vehicle of claim 2, further comprising fender members, wherein the overfender members are more pliant than the fender members.

6. An all-terrain vehicle comprising a central longitudinal plane, a pair of foot boards, the foot boards arranged between a pair of front wheels and a pair of rear wheels, the front wheels having a corresponding pair of rims and a maximum turning position, the foot boards having an outer edge, and the outer edge extending extending further outward from the central longitudinal plane than an outermost portion of the rims when the rims are in the maximum turning position.

7. The all-terrain vehicle of claim 6, wherein the outer edge has a reinforcing profile.

8. The all-terrain vehicle of claim 7, wherein the reinforcing profile has a burr pattern for increasing traction on an upper surface of the reinforcing profile.

9. The all-terrain vehicle of claim 6, further comprising a front fender assembly, wherein the front fender assembly is attached to the footboard.

10. The all-terrain vehicle of claim 9, wherein the front fender assembly includes a pliant overfender and the footboard is attached to the overfender.

11. The all-terrain vehicle of claim 9, further comprising a rear fender assembly wherein the footboard is also attached to the rear fender assembly.

12. The all-terrain vehicle of claim 11, wherein the front fender assembly includes a front overfender and the rear fender assembly includes a rear overfender and the footboard is attached to the front overfender and the rear overfender.

13. The all-terrain vehicle of claim 12, wherein the footboard includes an upwardly extending front flange adjacent the front fender assembly and an upwardly extending rear flange adjacent the rear fender assembly.

14. The all-terrain vehicle of claim 13, wherein the front flange is arranged closer to the front wheel than the front overfender to which the front flange is attached.

15. The all-terrain vehicle of claim 14, wherein the front flange is attached to the overfender with a threader fastener.

16. The all-terrain vehicle of claim 15, wherein the threaded fastener is partially shielded within a wheel well defined by the front fender assembly.

17. The all-terrain vehicle of claim 16, wherein a drip edge partially shields the threaded fastener.
